(19) United States
(12) Patent Application Publication
(10) Pub. No.: US 2005/0019626 A1
(43) Pub. Date: Jan. 27, 2005

(54) High-efficiency fuel processor via steam integration from a water-cooled stack

(76) Inventors: Steven D. Burch, Honeoye Falls, NY (US); John C. Fagley, Victor, NY (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 10/623,674

(22) Filed: Jul. 21, 2003

(51) Int. Cl. H01M 8/06; H01M 8/10

(52) U.S. Cl. 429/19; 429/20; 429/30

(57) ABSTRACT

Improving fuel processor efficiency via steam integration from a liquid-cooled high-temperature proton exchange membrane fuel cell (HT-PEMFC) stack is disclosed. A portion of the water used for stack cooling is re-condensed via ambient air and recycled to the HT-PEMFC stack. The remaining portion is diverted to the fuel processor to meet the fuel processor's steam needs. The entire fuel processor heat therefore is devoted to superheating the steam, and in some cases the fuel and/or air used in the reforming process.

### BACKGROUND OF THE INVENTION

The present invention relates generally to small-scale, highly integrated fuel cell systems and particularly, to improving fuel processor efficiency via steam integration from a water-cooled high temperature fuel cell stack.

A typical fuel cell system includes a fuel processor, a combustor, and a fuel cell stack to generate electricity useful for transportation and power generation applications. The typical fuel processor uses three steps to convert a liquid fuel, such as gasoline or methanol, or a gaseous fuel, such as methane, into a hydrogen-rich gaseous reformate that can be used to make electricity in the fuel cell stack. In the first step, the primary reactor (usually an auto thermal reactor (ATR) or steam reformer (SR)) converts the fuel to the gaseous reformate, but with significant (6% to 10%) carbon monoxide (CO). In the second step, a water-gas-shift reactor (WGS) is typically used to reduce the CO to 0.3% to 1% and increase the hydrogen content in the gaseous reformate. The final step is accomplished typically with either a partial oxidation (PrOx) reactor or a pressure-swing adsorption (PSA) device. In this step, the remaining CO present in the gaseous reformate is further reduced to about 2 to 50 part per million (ppm), depending on the fuel cell stack used.

The combustor is typically included in the fuel cell system to clean up residual methane and hydrogen that exits the fuel cell stack. Heat from the combustor is used to generate steam for the ATR and WGS reactors and in some cases, heat from the PrOx reactor may also be used for steam generation. The steam, and in some cases fuel and air is superheated via either the combustor heat or the heat from the gaseous reformate between the ATR and WGS reactors.

Current conventional proton exchange membrane fuel cell (PEMFC) stacks typically operate at about 60° C. to about 90° C., but new PEMFC stacks currently being developed will operate at much higher temperatures, such as for example, about 100° C. to 150° C. These high temperature PEMFC stacks will offer several advantages over conventional PEMFC stacks including easier stack heat rejection and greater CO tolerance. CO tolerance for a stack temperature of 100 to 150 C is estimated to be about 0.03% to about 0.5%. Additionally, further efficiency can be achieved in such fuel cell systems if the surplus heat produced by system components is utilized. Accordingly, there is a continued need to achieve higher overall system efficiencies in small-scale, highly integrated fuel cell systems.

### SUMMARY OF THE INVENTION

The present invention meets the above-mentioned need by providing a new source of steam generation for a fuel processor in a fuel cell system utilizing water vaporization cooling for a high temperature fuel cell stack. In particular, a portion of the steam generated from water used to cool the high temperature fuel cell stack is re-condensed via ambient air and recycled as coolant for the fuel cell stack. The remaining steam portion is diverted to the fuel processor to meet the fuel processor's steam needs. Accordingly, heat from the fuel processor and combustor can then be devoted entirely to superheating the steam, and in some cases the fuel and air inputs to a primary reactor.

In one embodiment, the present invention results in a significant reduction in the air needed by an auto-thermal reformer (ATR) based fuel processor because the feed streams are hotter than in prior art fuel cell systems due to preheating via a heat exchange utilizing the steam exiting the fuel cell stack. In this embodiment, less oxidation in the ATR based fuel processor is therefore required to meet a given outlet temperature. Accordingly, the fuel processor efficiency is increased. Furthermore, providing a sufficient steam to fuel carbon ratio (S:C) makes it possible to eliminate a partial oxidation (PrOx) reactor or a pressure-swing adsorption (PSA) device from the fuel processor, increasing fuel processor efficiency and decreasing fuel processor size and complexity.

Although the present invention is not limited to specific advantages or functionality, it is noted that the present invention increases fuel processor net efficiency for a given operational constraint. The present invention permits the ability to use higher S:C ratios thereby potentially reducing the size and cost of the primary reactor and water gas shift (WGS) reactors. It is also noted that the present invention improves the transient performance via improved steam availability.

In one embodiment, a fuel processor based fuel cell system is provided comprising a primary reactor adapted to generate a gaseous reformate from feed inputs. The feed inputs comprise steam. The system further includes a high temperature proton exchange membrane fuel cell (HT-PEMFC) stack in fluid communication with the primary reactor. The HT-PEMFC stack is adapted to receive the gaseous reformate for generating electrical power and to generate the steam needed for the primary reactor.

In another embodiment, a fuel processor based fuel cell system is provided comprising a reactant stream having steam, a primary reactor adapted to generate a gaseous reformate using the reactant stream, and a primary reactor heat exchanger in fluid communication with the primary reactor to preheat the reactant stream. The system also includes a high temperature proton exchange membrane fuel cell (HT-PEMFC) stack adapted to receive the gaseous reformate for generating electrical power. The HT-PEMFC stack is cooled by water and the steam is provided via water vaporization in the HT-PEMFC stack. The system further includes a catalytic combustor, and a superheat heat exchanger adapted to receive heat energy from the catalytic combustor to provide additional preheating to the reactant stream before being used in the primary reactor.

In still another embodiment, a fuel processor based fuel cell system is provided comprising a reactant stream having steam, and a primary reactor adapted to generate a gaseous reformate using the reactant stream. The system also includes a high temperature proton exchange membrane fuel cell (HT-PEMFC) stack adapted to receive the gaseous reformate for generating electrical power. The HT-PEMFC stack is cooled by water and the steam is provided via water vaporization in the HT-PEMFC stack. A water gas shift (WGS) reactor is in fluid communication between the primary reactor and the HT-PEMFC stack, and a primary reactor heat exchanger is situated between the primary reactor and the WGS reactor to preheat the reactant stream. The system further includes a catalytic combustor, and a superheat heat exchanger adapted to receive heat energy from the catalytic combustor to provide additional preheating to the reactant stream before being used in the primary reactor.

These and other features and advantages of the invention will be more fully understood from the following description of a preferred embodiment of the invention taken together with the accompanying drawings. It is noted that the scope of the claims is defined by the recitations therein and not by the specific discussion of features and advantages set forth in the present description.

### BRIEF DESCRIPTION OF THE DRAWINGS

The following detailed description of the embodiments of the present invention can be best understood when read in conjunction with the following drawings, where like structure is indicated with like reference numerals and in which:

FIG. 1 is an exemplary schematic diagram of one embodiment of the present invention;

FIG. 2 is a graph of a pinch analysis run on an embodiment of the present invention; and

FIG. 3 is a graph of a pinch analysis run on another embodiment of the present invention.

### DETAILED DESCRIPTION OF THE EMBODIMENTS OF THE INVENTION

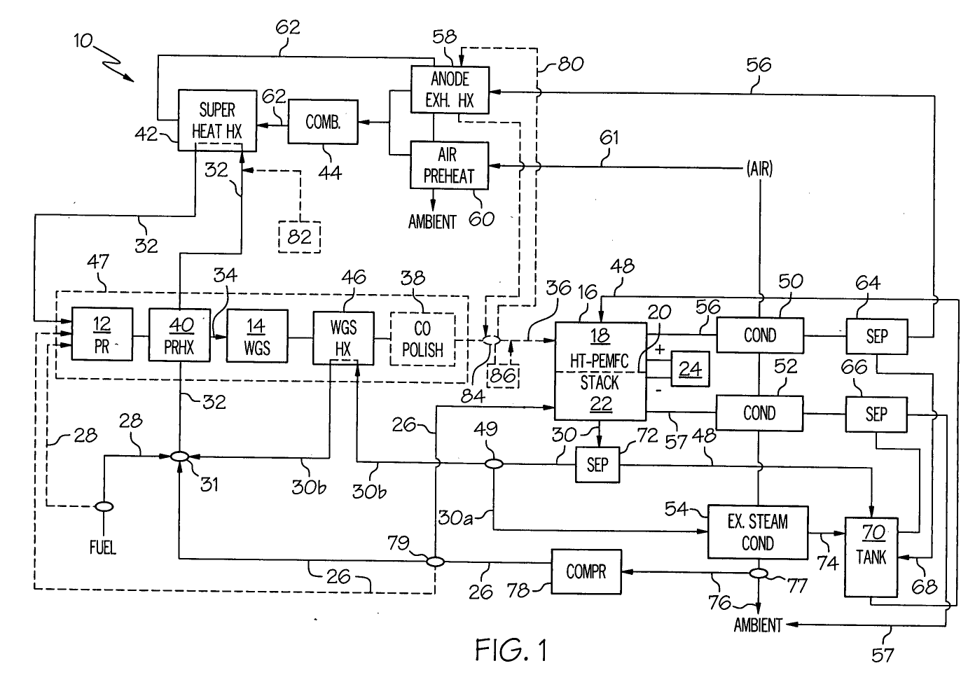

An exemplary schematic diagram of an embodiment of a fuel cell system 10 according to the present invention is shown by FIG. 1. The fuel cell system 10 includes a primary reactor 12 connected to a water gas shift (WGS) reactor 14, which in turn feeds gaseous reformate to a high temperature proton exchange membrane fuel cell (HT-PEMFC) stack 16. By “high temperature”, it is meant that the HT-PEMFC stack 16 has an operating range of about 100° C. to about 150° C. The primary reactor 12 in one embodiment is an auto-thermal reactor (ATR), which uses fuel, steam, and air as input streams to form the gaseous reformate. In another embodiment, the primary reactor 12 is a steam reformer (SR), which uses only fuel and steam as the input streams.

The HT-PEMFC stack 16 is a collection of fuel cells, which produces electricity by electrochemically combining hydrogen and oxygen to form water. The hydrogen is broken down into its components (protons and electrons) at an anode side 18 of each fuel cell which is represented collectively by one half of the HT-PEMFC stack 16. From the anode side 18 the protons pass through an electrolyte 20 of each fuel cell to a cathode side 22, which is also collectively represented by the other half of the HT-PEMFC stack 16. The electrons, however, are forced to pass through an external circuit, thereby supplying electrical power to an external load 24.

The oxygen needed at the cathode side 22 of the HT-PEMFC stack 16 is taken from air 26 that has been pressurized and humidified. The hydrogen required for the anode side 18 of the HT-PEMFC stack 16 is extracted from a hydrogen-containing fuel 28 in a process called reforming. In one embodiment, the fuel 28 is combined with compressed air 26 and steam 30, via a mixing port 31, into a reactant stream 32 which is superheated and then fed into the primary reactor 12. In another embodiment, the fuel 28 is combined with the steam 30 to form the reactant stream 32 which is superheated and then combined with the compressed air 26 in the primary reactor 12. In still another embodiment, the compressed air 26 is combined with the steam 30 to form the reactant stream 32 which is superheated and then combined with the fuel 28 in the primary reactor 12. In yet another embodiment, the reactant stream 32 comprises only the steam 30 which is superheated and then combined with the compressed air 26 and the fuel 28 in the primary reactor 12.

During the reforming process, the primary reactor 12 breaks down the reactant stream 32 into hydrogen-rich gaseous reformate 34 along with other byproducts. One particular byproduct is carbon monoxide (CO), which is harmful to the catalyst present in the HT-PEMFC stack 16. Accordingly, CO is reduced and/or removed by feeding the gaseous reformate 34 directly into the water gas shift (WGS) reactor 14, where the CO is converted into CO₂. The reduced-CO gaseous reformate 36 is fed optionally into a final CO-polishing stage 38, such as a partial oxidation (PrOx) reactor or a pressure swing absorber (PSA). Next, the gaseous reformate 36 is then fed into the anode side 18 of the HT-PEMFC stack 16 to provide hydrogen and humidification in order to produce electricity for load 24.

As illustrated in FIG. 1, a primary reactor heat exchanger (PRHX) 40 is situated between the primary reactor 12 and the WGS reactor 14 to preheat the reactant stream 32. Additional preheating is provided to the reactant stream 32 through a superheat HX 42 exchanging heat from a catalytic combustor 44. A WGS reactor heat exchanger (WGS HX) 46 that is provided between the WGS reactor 14 and HT-PEMFC stack 16 also provides the steam 30 an initial boost of heat energy before entering the PRHX 40 and superheater 42.

It is to be appreciated that the primary and WGS reactors 12 and 14, respectively, their respective heat exchangers 40 and 46, and the optional final CO-polishing stage 38 represent collectively a fuel processor 47. Furthermore, in the above-illustrated embodiment the present invention provides a new source for the generation of the steam 30 needed for the reforming process carried out in the primary reactor 12 of the fuel processor 47. In one embodiment, steam 30 is provided via water vaporization of water 48 used as a coolant in the HT-PEMFC stack 16. It is to be appreciated that water 48 may contain additives, such as glycols, and other chemicals which depress the freezing point of water.

Within the HT-PEMFC stack 16, the water 48 is vaporized into a relatively large quantity of steam 30 in cooling channels (not shown) provided adjacent to the anode and cathode sides 18 and 22, respectively, by the heat of the reaction. This large quantity of generated steam 30 is then divided into a first steam portion 30a and a second steam portion 30b by a steam diverter 49. In one embodiment, the first steam portion 30a is about two-thirds to about one-half of the vaporized water in the steam 30, which is recondensed and recycled to the HT-PEMFC stack 16 for cooling needs. The second steam portion 30b is the remaining third to one-half of the vaporized water in the steam 30, which is diverted to the primary reactor 12 to meet the steam requirements of the reforming process.

With the above described embodiment, a substantial portion of the heat generated by the primary reactor 12 and combustor 44 is then devoted to superheating the reactant stream 32 comprising at least the second steam portion 30b, and in some cases, air 26 and/or fuel 28. In one embodiment utilizing an ATR as the primary reactor 12, devoting more heat to superheating results in a significant reduction in the air 26 needed by the ATR. It is to be appreciated that less air 26 is needed in this embodiment because the liquid mixture 32 is then hotter, so that less oxidation inside the ATR is required to meet a given outlet temperature. Accordingly, a net increase in fuel processor efficiency is provided.

Because in all embodiments the HT-PEMFC stack 16 operates at a higher temperature than prior art PEMFC stacks, additional heat recovery is also provided by anode and cathode condensers 50 and 52, respectively, as well as with a stack excess steam condenser 54. The steam condenser 54 is used to recondense the first steam portion 30a. Additionally, because not all of the hydrogen in the gaseous reformate 36 is consumed in the HT-PEMFC stack 16, anode exhaust 56 containing excess hydrogen is fed into the combustor 44 to maintain the temperature required for the reforming process. Before entering into the combustor 44, the anode exhaust 56 is preheated by an anode exhaust preheat HX 58, as well as the air 61 used in the combustor 44 by a combustor air preheat HX 60. As illustrated, exhaust 62 of the combustor 44 provides the heat input to the superheat HX 42, the anode exhaust preheat HX 58, and the combustor air preheat HX 60 before exiting to ambient.

Water 48 is also recovered from anode and cathode exhausts 56 and 57, respectively, to maintain the necessary water supply to the primary reactor 12. Anode and cathode exhaust liquid separators 64 and 66 are provided for this purpose, supplying water 68 to a coolant tank 70. It is to be appreciated that the anode and cathode exhaust liquid separators 64 and 66, respectively, remove enough water from the anode exhaust 56 and the cathode exhaust 57 exiting the HT-PEMFC stack 16 to make the fuel cell system 10 water neutral. A stack coolant liquid separator 72 is also provided to separate the liquid water 48 from the steam 30 exiting the HT-PEMFC stack 16, wherein the liquid water 48 from the separator 72 is returned to the coolant tank 70.

As mentioned previously, the first steam portion 30a is recondensed in the stack excess steam condenser 54, wherein its condensate 74 is received by the coolant tank 70. Heated air 76 used to condense the first steam portion 30a is first preheated by the anode and cathode condensers 50 and 52, respectively. The heated air 76 exiting the cathode condenser 52 will be heated towards the two-phase temperature of water (about 100° C.). After exiting the steam condenser 54, a portion of the heated air 76 is then pulled into a compressor 78, such as through an access port 77, with excess heated air exiting to ambient.

As illustrated, the compressor 78 feeds the cathode side 22 of the HT-PEMFC stack 16 and the primary reactor 12 with portions of heated compressed air 26 through an air diverter 79. This feed arrangement of compressed air 26 minimizes the possibility that the water 48 will recondense in the inlet of the HT-PEMFC stack 16. In addition, in the embodiment where the compressed air 26 is provided as part of the reactant stream 32, supplying heated compressed air 26 will minimize the possibility that the water 48 will recondense in the inlet of the PRHX 40.

In still other embodiments, alternative component arrangements are useful for system startup. For example, a bypass circuit 80 is used to divert the gaseous reformate 36 into the anode exhaust preheat HX 58 to provide greater heat input to the anode exhaust 56 at startup before sending the gaseous reformate to the HT-PEMFC stack 16. In still another embodiment, a water injector 82 is used to put water into the reactant stream 32 prior to entering into superheat HX 42. This injected water flashes to steam in the superheat HX 42 in order to provide the required steam for the primary reactor 12 at startup.

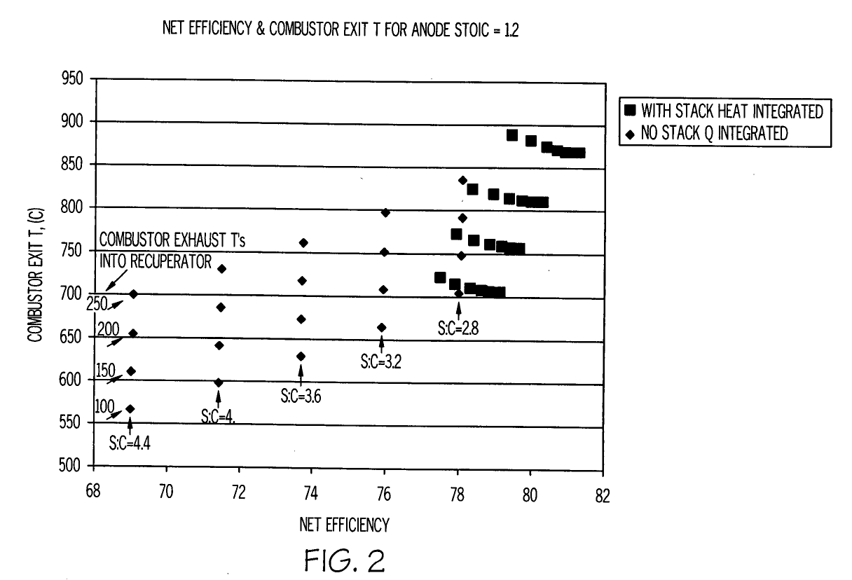

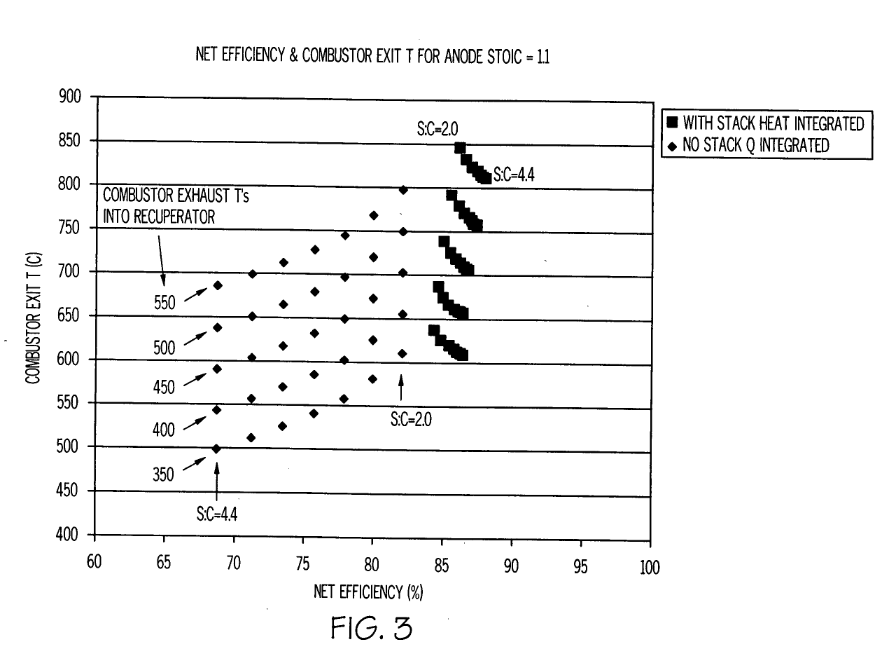

With reference to FIGS. 2 and 3, a pinch analysis was performed to estimate the potential increase in fuel processor efficiency. In particular, FIG. 2 is a plot of fuel processor net efficiency which is defined as hydrogen power consumed in the HT-PEMFC stack 16 divided by the fuel energy consumed in the primary reactor 12 based on a system with an anode stoichiometry of 1.2. The results for a fuel cell system having stack heating (Q) according to the present invention i.e., use of the second steam portion 30b as a steam source for the primary reactor 12, are plotted as square symbols. The results for a fuel cell system not having stack heating i.e., all steam 30 is recondensed and returned to coolant tank 70 and steam is provided via alternative means, are plotted as diamond symbols.

As illustrated by FIG. 2, for all “No Stack Q” points with net efficiency below 76%, the pinch temperature (T) is about 500 C. For all “With Stack Q” points, pinch temperatures are above 680° C. The results of the pinch analysis for the embodiment of FIG. 2 indicates that with no stack heating such as with conventional fuel cell systems, the best efficiency achievable is about 79.9% with a ratio of steam to fuel carbon (S:C) equal to about 2.4. With stack heating provided in accordance with the present invention, however, the efficiencies achievable are according to Table 1.

TABLE 1

| % Efficiency | S:C |
|---|---|
| 81.3 | 4.4 |
| 81.1 | 4 |
| 80.9 | 3.6 |
| 80.6 | 3.2 |
| 80.4 | 2.8 |
| 79.9 | 2.4 |

FIG. 3 is a similar plot to that of FIG. 2 but for a system with anode stoichiometry of 1.1. For all “No Stack Q” points, the pinch temperature is 50° C. For all “With Stack Q” points, pinch temperatures are above 700° C. The results of the pinch analysis for the embodiment of FIG. 3 indicates that with no stack heating such as with conventional fuel cell systems, the best efficiency achievable is about 81.9% with a S:C ratio equal to about 2.0. However, with stack heating in accordance with the present invention the best efficiency is about 87.8% with a S:C ratio equal to about 4.4, and even with a S:C ratio equal to about 2.0, efficiency is about 86.0%.

It can be seen from the plots of FIGS. 2 and 3 that integrating stack heat via water vaporization significantly increases net fuel processor efficiency. Furthermore, integrating stack heat via water vaporization enables a broader range of S:C operation while maintaining a relatively high efficiency. It is envisioned that using a higher S:C ratio may be preferable to reduce the size and cost of the primary and WGS reactors 12 and 14, respectively. Further, it is envisioned that using a higher S:C ratio may decrease or eliminate the need for providing both the final CO-polishing stage 38 and additional stack humidification.

It is to be appreciated that the efficiency gain in the present invention is realized by incorporating heat from the HT-PEMFC stack 16 into the primary reactor 12. Heat from the gaseous reformate 34 and combustor 44, which had previously been used for steam generation in conventional fuel cell system, is now used to superheat the reactant stream 32. In one embodiment which uses an ATR for the primary reactor 12, this higher preheating of the reactant stream 32 results in significantly lower requirements for compressed air 26. For example, in the embodiment having the anode stoic equal to 1.1 (FIG. 3) the ratio of atomic oxygen in air flow to carbon in fuel flow (O:C) increases nearly linearly from about 1.0 to about 1.5 as the S:C ratio is increased from about 2 to about 4.4 for the example without stack heat integration, but is fairly steady between about 0.75 and about 0.8 for the embodiment with stack heat integration. This lower fuel processor air requirement reduces the size, cost, and parasitic energy consumption of the moving hardware of the compressor 78.

The levels of efficiency obtained via stack heat integration (particularly with anode stoic of 1.1) not only surpass those of conventional ATR-based fuel processors, but also that of similarly pressurized steam-reformer based fuel processors. The values are similar to very high-pressure (10 to 20 bar) steam reformer based fuel processor systems, but retain the advantages of ATR-based fuel processors such as, for example, lower mass and volume, faster startup, better transients, and lower capital costs.

In addition to enhanced steady-state efficiency, the fuel cell system 10 of the present invention aids in fuel processor transients. For example, in a conventional fuel processor if a step change in power from 50% to 100% is requested, a lag of several seconds (often up to one minute) is typical in order for the additional steam generation to be established. This lag in steam generation typically makes such conventional systems have to either accept much higher CO during this period or limit the rate of power change. However, because excess steam 30 is generated by the HT-PEMFC stack 16 in the fuel cell system 10, in an up-transient state, all steam 30 in one embodiment is diverted, via adjusting steam diverter 49, to the primary reactor 12 until the lag of the system is overcome and/or the system reached its new steady state. The ability to control the relative portion of stack generated steam 30 to the primary reactor 12 via diverter 49 also leads to better CO control and the ability to double or triple power in a step-wise fashion.

As described above, the fuel processor-based fuel cell system 10 uses water as a two-phase stack coolant (liquid and steam) and draws a portion of generated steam for use in the fuel processor 47, thereby resulting in a significantly improved system steady-state efficiency and transient response. Preferably, in one embodiment, the fuel cell system 10 uses a S:C ratio in the primary reactor 12 of about 2 to about 5, and most preferably in another embodiment a S:C ratio of about 3 to about 4 to minimize the size and cost of the WGS reactor 14 and to minimize or eliminate the need for the final CO polishing stage 38.

Depending on the humidity required by the HT-PEMFC stack 16, the fuel processor 47 can provide significant stack humidification, for example, about 20 to about 25% of the total relative humidity based on stack outlet conditions. In addition, if no humidification is desired, in another embodiment the water content can be removed from the gaseous reformate 36 before entering the HT-PEMFC stack 16 by directing the gaseous reformate via a bypass value 84 to a separator 86 provided between the HT-PEMFC stack 16 and fuel processor 47. The bypass value 84 may also be used to service the bypass circuit 80 to divert the gaseous reformate 36 into the anode exhaust preheat HX 58 to provide greater heat input to the anode exhaust 56 at startup.

While the invention has been described by reference to certain preferred embodiments, it should be understood that numerous changes could be made within the spirit and scope of the inventive concepts described. Accordingly, it is intended that the invention not be limited to the disclosed embodiments, but that it have the full scope permitted by the language of the following claims.

1. A fuel processor based fuel cell system comprising:
a primary reactor adapted to generate a gaseous reformate from feed inputs comprising steam; and
a high temperature proton exchange membrane fuel cell (HT-PEMFC) stack in fluid communication with the primary reactor, said HT-PEMFC stack is adapted to receive the gaseous reformate for generating electrical power and to generate the steam needed for the primary reactor.

2. A fuel processor based fuel cell system according to claim 1 wherein the feed inputs further comprises air, a hydrogen-containing fuel, and combinations thereof.

3. A fuel processor based fuel cell system according to claim 1 further comprising a water gas shift (WGS) reactor in fluid communication between the primary reactor and the HT-PEMFC stack, and a primary reactor heat exchanger in fluid communication between the primary reactor and the WGS reactor to heat at least the steam before being used in the primary reactor with heat energy from the gaseous reformate.

4. A fuel processor based fuel cell system according to claim 1 further comprising a catalytic combustor in fluid communication with a superheat heat exchanger to heat at least the steam before being used in the primary reactor with heat energy from the catalytic combustor.

5. A fuel processor based fuel cell system according to claim 1 further comprising a WGS reactor heat exchanger provided in fluid communication between a WGS reactor and the HT-PEMFC stack, the WGS reactor heat exchanger is adapted to heat the steam before being used in the primary reactor with heat energy from the gaseous reformate.

6. A fuel processor based fuel cell system according to claim 1 wherein the primary reactor is selected from the group consisting of an auto-thermal reactor and a steam reformer.

7. A fuel processor based fuel cell system according to claim 1 further comprising a stack excess steam condenser, and wherein a portion of about two-thirds to about one-half of vaporized water in the steam is recondensed in the stack excess steam condenser and recycled to the HT-PEMFC stack for cooling needs.

8. A fuel processor based fuel cell system according to claim 1 wherein a portion of about one-third to one-half of vaporized water in the steam is used in the primary reactor.

9. A fuel processor based fuel cell system according to claim 1 further comprising a catalytic combustor, and wherein excess hydrogen unconsumed by the HT-PEMFC stack in a catalyst reaction using the gaseous reformate is fed into the catalytic combustor to maintain a temperature required for producing the gaseous reformate in the primary reactor.

10. A fuel processor based fuel cell system according to claim 1 further comprising a catalytic combustor in fluid communication with a combustor air preheat heat exchanger which is adapted to receive heat energy from combustor exhaust and to preheat air used in the catalytic combustor.

11. A fuel processor based fuel cell system according to claim 1 further comprising anode and cathode exhaust liquid separators adapted to recover water from anode and cathode exhausts from the HT-PEMFC stack.

12. A fuel processor based fuel cell system according to claim 1 further comprising a stack coolant liquid separator to separate liquid water from the steam exiting the HT-PEMFC stack.

13. A fuel processor based fuel cell system according to claim 1 further comprising anode and cathode exhaust condensers and a compressor adapted to provide compressed air to the HT-PEMFC stack, each of the anode and cathode exhaust condensers is adapted to receive heat energy from a respective exhaust from the HT-PEMFC and to heat air used by the compressor.

14. A fuel processor based fuel cell system according to claim 13 further comprising a stack excess steam condenser, wherein the air is also used to condense a portion of the steam provided to the excess steam condenser before being fed to the compressor.

15. A fuel processor based fuel cell system according to claim 1 further comprising an anode exhaust preheat heat exchanger receiving anode exhaust from the HT-PEMFC stack and a bypass circuit used to divert the gaseous reformate into the anode exhaust preheat heat exchanger to provide greater heat input to the anode exhaust before sending the gaseous reformate to the HT-PEMFC stack.

16. A fuel processor based fuel cell system according to claim 1 wherein the primary reactor has an anode stoichiometry from about 1.0 to about 1.3, and preferably from about 1.1 and about 1.2.

17. A fuel processor based fuel cell system according to claim 1 wherein the primary reactor uses a ratio of steam to fuel carbon (S:C) from about 2 to about 5.

18. A fuel processor based fuel cell system according to claim 1 wherein the primary reactor uses a ratio of atomic oxygen in air flow to carbon in fuel flow (O:C) from about 0.6 to about 1.5, and preferably from about 0.75 to about 0.8.

19. A fuel processor based fuel cell system according to claim 1 wherein all the steam is fed to the primary reactor.

20. A fuel processor based fuel cell system according to claim 1 further comprising a water/steam separator to remove excess water contained in the gaseous reformate before being fed to the HT-PEMFC stack.

21. A fuel processor based fuel cell system comprising:
a reactant stream comprising steam;
a primary reactor adapted to generate a gaseous reformate using the reactant stream;
a primary reactor heat exchanger in fluid communication with the primary reactor to preheat the reactant stream;
a high temperature proton exchange membrane fuel cell (HT-PEMFC) stack adapted to receive the gaseous reformate for generating electrical power, the HT-PEMFC stack being cooled by water and the steam being provided via water vaporization of the water in the HT-PEMFC stack;
a catalytic combustor; and
a superheat heat exchanger adapted to receive heat energy from the catalytic combustor to provide additional preheating to the reactant stream before being used in the primary reactor.

22. A fuel processor based fuel cell system according to claim 21 wherein the reactant stream further comprises a hydrogen-containing fuel, air, and combinations thereof.

23. A fuel processor based fuel cell system according to claim 21 wherein the reactant stream is superheated in the superheat heat exchanger and then combined with compressed air before being used in the primary reactor.

24. A fuel processor based fuel cell system according to claim 21 wherein the reactant stream is superheated in the superheat heat exchanger and then combined with compressed air and a hydrogen-containing fuel before being used in the primary reactor.

25. A fuel processor based fuel cell system according to claim 21 further comprising a water gas shift (WGS) reactor provided in fluid communication with the primary reactor, a WGS heat exchanger in fluid communication with the WGS reactor, and an optional final CO-polishing stage provided in fluid communication between the WGS heat exchanger and the HT-PEMFC stack.

26. A fuel processor based fuel cell system according to claim 21 wherein anode exhaust from the HT-PEMFC stack before entering into the combustor to be consumed is preheated by an anode exhaust preheat heat exchanger which is adapted to receive heat energy from combustor exhaust.

27. A fuel processor based fuel cell system according to claim 21 further comprising a water injector used to put water into the reactant stream prior to entering into the superheat heat exchanger in order to provide the required steam for the primary reactor at startup.

28. A fuel processor based fuel cell system comprising:
a reactant stream comprising steam;
a primary reactor adapted to generate a gaseous reformate using the reactant stream;
a high temperature proton exchange membrane fuel cell (HT-PEMFC) stack adapted to receive the gaseous reformate for generating electrical power, the HT-PEMFC stack being cooled by water and the steam being provided via water vaporization of the water in the HT-PEMFC stack;
a water gas shift (WGS) reactor in fluid communication between the primary reactor and the HT-PEMFC stack;
a primary reactor heat exchanger situated between the primary reactor and the WGS reactor to preheat the reactant stream;
a catalytic combustor; and
a superheat heat exchanger adapted to receive heat energy from the catalytic combustor to provide additional preheating to the reactant stream before being used in the primary reactor.
